(19) United States
(12) Patent Application Publication
(10) Pub. No.: US 2026/0094851 A1
(43) Pub. Date: Apr. 2, 2026

(54) ELECTROLYTE MEMBRANE FOR PATTERNED MEMBRANE-ELECTRODE ASSEMBLY AND METHOD FOR PREPARING SAME

(71) Applicants: Hyundai Motor Company, Seoul (KR); Kia Corporation, Seoul (KR); Kookmin University Industry Academic Cooperation, Seoul (KR)

(72) Inventors: Songi Oh, Hwaseong (KR); Won Jae Choi, Hwaseong (KR); So Hwa Kim, &Hwaseong (KR); Da Hee Kwak, Hwaseong (KR); Ah Hyeon Park, Hwaseong (KR); Jee Youn Hwang, Hwaseong (KR); Sung Hee Shin, Hwaseong (KR); Se Geun Jang, Daejeon (KR); Sang Hyeok Lee, Cheonan (KR); Yeon Jae Lee, Seoul (KR)

(21) Appl. No.: 19/293,582

(22) Filed: Aug. 7, 2025

(30) Foreign Application Priority Data
Sep. 10, 2024 (KR) 10-2024-0122753

(51) Int. Cl. H01M 8/1023; C25B 13/08; H01M 8/10

(52) U.S. Cl. CPC H01M 8/1023; C25B 13/08; H01M 2008/1095; H01M 2300/0082

(57) ABSTRACT

A hydrocarbon-based ion exchange membrane is hydrated, then compressed with a mesh template to form an embedded pattern on its surface. After dehydration, the template is removed, yielding an electrolyte membrane featuring improved water uptake, ion conductivity, and mechanical properties. The method supports large-area production at about 70° C. to 90° C. under pressures of about 5 MPa to 15 MPa. A catalyst slurry can be applied to the patterned membrane to create a membrane-electrode assembly, enhancing bonding strength and catalyst utilization in electrochemical devices such as fuel cells and water electrolyzers. The resulting membrane has a moisture content of about 60% by weight or more, a Young's modulus of about 100 MPa or less, and a pattern depth of about 40% or greater relative to the template wires.

### CROSS-REFERENCE TO RELATED APPLICATION

This application claims under 35 U.S.C. § 119 (a) the benefit of Korean Patent Application No. 10-2024-0122753 filed on Sep. 10, 2024, the entire contents of which are incorporated herein by reference.

### BACKGROUND

### Technical Field

The present disclosure relates to a method for preparing an electrolyte membrane for a patterned membrane-electrode assembly by using the function characteristics of a hydrocarbon-based ion exchange membrane.

### Background

There have been many reports on the studies of applying surface patterning technology of ion exchange membranes to electrochemical devices such as fuel cells and water electrolysis devices. The structural modification through patterning of an ion exchange membrane may promote the movement of water and hydrogen ions in a locally thinned portion within the ion exchange membrane. In addition, the interface between the ion exchange membrane and the electrode may be expanded to increase the utilization rate of the catalyst, and the bonding force between the ion exchange membrane and the electrode may be increased to improve durability. Since fluorine-based ion exchange membranes represented by Nafion have a low glass transition temperature of about 100° C., patterns can be easily formed using thermal imprinting technology.

However, since hydrocarbon-based ion exchange membranes have a high glass transition temperature of about 200° C., applying thermal imprinting technology requires temperatures at or above that glass transition temperature, which may deteriorate the main chain and side chain of the membrane. Accordingly, technologies for patterning hydrocarbon-based ion exchange membranes have conventionally been reported, by using 1) a method of pouring an ionomer solution, not in the form of an ion exchange membrane, onto a patterned substrate and drying it, 2) a method of forming a three-dimensional structure by coating the nanoparticles along with an ionomer solution on a substrate and then removing the nanoparticles, and 3) a method such as physical and/or chemical etching using plasma and a mask. However, the method using an ionomer solution makes it difficult to produce a large-area ion exchange membrane and precludes the use of commercial ion exchange membranes. The method using nanoparticles requires a post-treatment process to remove the nanoparticles and has a high production cost. The physical and/or chemical etching may cause the ion exchange membrane to deteriorate due to plasma irradiation.

### SUMMARY OF THE DISCLOSURE

An object of the present disclosure is to provide an electrolyte membrane for a patterned membrane-electrode assembly that is advantageous for large-area production and a method for preparing the same.

Another object of the present disclosure is to provide a preparation method that can pattern an electrolyte membrane without affecting mechanical properties and electrochemical properties.

Still another object of the present disclosure is to provide an electrolyte membrane for a patterned membrane-electrode assembly that is advantageous for mass production and a method for preparing the same.

The objects of the present disclosure are not limited to the objects mentioned above. The objects of the present disclosure will become more apparent from the following description and will be realized by means and combinations thereof described in the claims.

In one aspect, a method for preparing an electrolyte membrane for a membrane-electrode assembly, the method comprising: a) obtaining a first intermediate by hydrating a hydrocarbon-based ion exchange membrane; b) obtaining a second intermediate by stacking a template on at least one surface of the first intermediate and applying pressure in the stacking direction; and c) obtaining the electrolyte membrane by dehydrating the second intermediate and removing the template from the second intermediate, wherein the electrolyte membrane comprises a pattern having a shape corresponding to template.

In a further aspect, a method for preparing an electrolyte membrane for a membrane-electrode assembly according to one embodiment of the present disclosure may include steps of: obtaining a first intermediate by hydrating (water uptake) a hydrocarbon-based ion exchange membrane; obtaining a second intermediate by stacking a template having a predetermined shape on at least one surface of the first intermediate and applying pressure in the stacking direction; and obtaining the electrolyte membrane by dehydrating the second intermediate and removing the template from the second intermediate.

A pattern having a shape corresponding to the shape of the template may be formed to be embedded in at least one surface of the electrolyte membrane.

The step of obtaining the first intermediate may be immersing the hydrocarbon-based ion exchange membrane in a solvent at 70° C. to 90° C. for 4 to 6 hours.

The first intermediate obtained by immersing the hydrocarbon-based ion exchange membrane in a solvent at 80° C. for 4 hours may have a moisture content of 60% by weight or more.

When the hydrocarbon-based ion exchange membrane is immersed in a solvent at 80° C. for 4 hours, the hydrocarbon-based ion exchange membrane may have a length change rate of 10% or more.

When the hydrocarbon-based ion exchange membrane is immersed in a solvent at 80° C. for 4 hours, the hydrocarbon-based ion exchange membrane may have a thickness change rate of 30% or more.

The first intermediate obtained by immersing the hydrocarbon-based ion exchange membrane in a solvent at 80° C. for 4 hours may have a Young's modulus of 100 MPa or less.

The template may have a mesh-shape in which wires are intertwined in a net-like shape.

The template may have a stiffness higher than a stiffness of the first intermediate.

The template may be made of stainless steel.

The template may have a width of 300 mm or more and a length of 500 mm or more, and the first intermediate may have a size equal to or larger than a size of the template.

The template may have a width of 300 mm or more and a length of 500 mm or more, and the first intermediate may have a size equal to or smaller than a size of the template.

The step of obtaining the second intermediate may be stacking the template on at least one surface of the first intermediate, and applying a pressure of 5 MPa to 15 MPa in the stacking direction at 70° C. to 90° C.

The step of obtaining the electrolyte membrane may be dehydrating the second intermediate by compressing it at 70° C. to 90° C. for 1 hour to 2 hours and removing the template.

A method for manufacturing a membrane-electrode assembly according to one embodiment of the present disclosure may include a step of applying a catalyst slurry to both surfaces of the electrolyte membrane to manufacture a pair of electrodes, wherein the electrodes may be filled in spaces of the electrolyte membrane formed to be embedded.

An electrolyte membrane for a membrane-electrode assembly according to one embodiment of the present disclosure may include a hydrocarbon-based ion exchange membrane, wherein the hydrocarbon-based ion exchange membrane may have a pattern with a shape corresponding to a pattern of a template, the pattern being formed to be embedded in at least one surface thereof, and the template may have a mesh-shape in which wires are intertwined in a net-like shape.

When the hydrocarbon-based ion exchange membrane is immersed in a solvent at 80° C. for 4 hours, the hydrocarbon-based ion exchange membrane may have a moisture content of 60% by weight or more.

When the hydrocarbon-based ion exchange membrane is immersed in a solvent at 80° C. for 4 hours, the hydrocarbon-based ion exchange membrane may have a longitudinal change rate of 10% or more.

When the hydrocarbon-based ion exchange membrane is immersed in a solvent at 80° C. for 4 hours, the hydrocarbon-based ion exchange membrane may have a width directional change rate of 30% or more.

When the hydrocarbon-based ion exchange membrane is immersed in a solvent at 80° C. for 4 hours, the hydrocarbon-based ion exchange membrane may have a Young's modulus of 100 MPa or less.

The pattern formed to be embedded in the hydrocarbon-based ion exchange membrane may have a depth of 40% or more of the diameter of the cross section of the wires of the template.

According to the present disclosure, an electrolyte membrane for a patterned membrane-electrode assembly, which is advantageous for large-area production, and a method for preparing the same can be obtained.

According to the present disclosure, an electrolyte membrane can be patterned without affecting mechanical properties and electrochemical properties.

According to the present disclosure, an electrolyte membrane for a patterned membrane-electrode assembly, which is advantageous for mass production, and a method for preparing the same can be obtained.

According to the present disclosure, since the ion exchange membrane is patterned using the function characteristics of the ion exchange membrane, an electrolyte membrane for a membrane-electrode assembly, of which preparation process is environmentally friendly and harmless to humans, and a method for preparing the same can be obtained.

According to the present disclosure, an electrolyte membrane for a membrane-electrode assembly, in which water and hydrogen ions are smoothly transferred, and a method for preparing the same can be obtained.

According to the present disclosure, an electrolyte membrane for a membrane-electrode assembly, which has excellent bonding force between an ion exchange membrane and an electrode, and a method for preparing the same can be obtained.

According to the present disclosure, an electrolyte membrane for a membrane-electrode assembly, which has a high utilization rate of a catalyst by having a wide interface between an ion exchange membrane and an electrode, and a method for preparing the same can be obtained.

As discussed, the method and system suitably include use of a controller or processer. The effects of the present disclosure are not limited to the effects mentioned above. It should be understood that the effects of the present disclosure include all effects that can be inferred from the following description.

### BRIEF DESCRIPTION OF THE DRAWINGS

FIG. 1 illustrates a membrane-electrode assembly according to the present disclosure.

FIG. 2 is for explaining a step of obtaining a first intermediate.

FIG. 3 is for explaining a step of obtaining a second intermediate.

FIG. 4 is for explaining a step of obtaining an electrolyte membrane.

FIG. 5 is for explaining a method for manufacturing a membrane-electrode assembly according to the present disclosure.

FIG. 6 is an enlarged view of a cross-section of a membrane-electrode assembly according to the present disclosure.

FIG. 7 shows length change rates, thickness change rates, and moisture contents of the first intermediates according to Preparation Example 1-1, Comparative Preparation Example 1-1, and Comparative Preparation Example 2-1.

FIG. 8 shows tensile strengths of the first intermediates according to Preparation Example 1-1, Comparative Preparation Example 1-1, and Comparative Preparation Example 2-1.

FIG. 9 is a template used in Preparation Example 1-2.

FIG. 10 is an optical image of the template of FIG. 9.

FIG. 11 is a laser profile image of the template of FIG. 9.

FIG. 12 is optical images and laser profile images of the electrolyte membrane according to Comparative Preparation Example 1-2.

FIG. 13 is optical images and laser profile images of the electrolyte membrane according to Comparative Preparation Example 2-2.

FIG. 14 is optical images and laser profile images of the electrolyte membrane according to Preparation Example 1-2.

FIG. 15 are images illustrating results of analyzing the surface and cross-section of the electrolyte membrane according to Comparative Preparation Example 1-2 using a scanning electron microscope.

FIG. 16 are images illustrating results of analyzing the surface and cross-section of the electrolyte membrane according to Comparative Preparation Example 2-2 using a scanning electron microscope.

FIG. 17 are images illustrating results of analyzing the surface and cross-section of the electrolyte membrane according to Preparation Example 1-2 using a scanning electron microscope.

FIG. 18 are images illustrating results of analyzing the surface and cross-section of the membrane-electrode assembly according to Comparative Example using a scanning electron microscope.

FIG. 19 are images illustrating results of analyzing the surface and cross-section of the membrane-electrode assembly according to Example using a scanning electron microscope.

FIG. 20 is a graph illustrating results of measuring adhesion strengths of the membrane-electrode assemblies according to Example and Comparative Example.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, dimensions of the structures have been enlarged from the actual size for clarity of the present disclosure. Terms such as first, second, etc. may be used to describe various components, but the components should not be limited by the terms.

The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part, but also the case where there is another part in the middle therebetween. Conversely, when a part of a layer, film, region, plate, etc. is said to be “under” other part, this includes not only the case where it is “directly under” the other part, but also the case where there is another part in the middle therebetween.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous, and includes all values from a minimum value of such a range to the maximum value including a maximum value, unless otherwise indicated. Furthermore, when such a range refers to an integer, all integers including from the minimum value to the maximum value including a maximum value are included, unless otherwise indicated.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

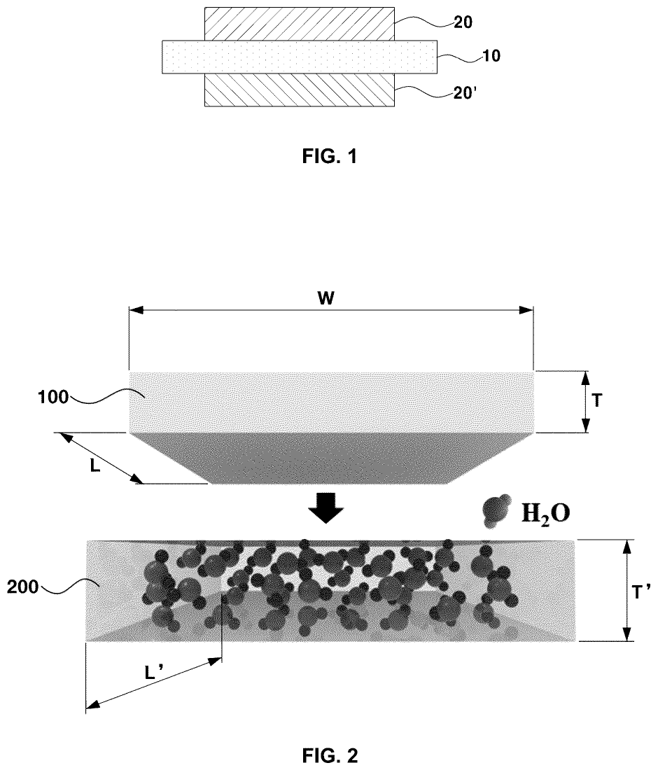

FIG. 1 illustrates a membrane-electrode assembly according to the present disclosure. The membrane-electrode assembly may be used in electrochemical devices such as fuel cells, water electrolysis cells, etc. The membrane-electrode assembly may include an electrolyte membrane 10 and electrode layers 20 and 20′ on the electrolyte membrane 10. When the electrode layer 20 on one surface of the electrolyte membrane 10 is a cathode, the electrode layer 20′ on the other surface thereof may be an anode.

A method for preparing an electrolyte membrane 10 for a membrane-electrode assembly according to the present disclosure may include steps of obtaining a first intermediate by hydrating (water uptake) a hydrocarbon-based ion exchange membrane, obtaining a second intermediate by stacking a template having a predetermined shape on at least one surface of the first intermediate and applying pressure in the stacking direction, and obtaining the electrolyte membrane by dehydrating the second intermediate and removing the template from the second intermediate.

In some embodiments, the term “predetermined shape” refers to any intentionally formed geometric configuration or pattern that a template is designed to imprint onto the hydrocarbon-based ion exchange membrane. This shape may be a mesh pattern, a lattice, or any other structural arrangement engineered to impart a corresponding embedded pattern onto the membrane surface under pressure. The shape is “predetermined” in that it is established prior to contacting the membrane (e.g., by manufacturing or selecting a template with a specific geometry), and remains consistent through the imprinting process.

FIG. 2 is for explaining the step of obtaining the first intermediate. Referring to FIG. 2, the first intermediate 200 may be obtained by hydrating the hydrocarbon-based ion exchange membrane 100.

The hydrocarbon-based ion exchange membrane 100 is not particularly limited in type, and may include, for example, polyethersulfone, cross-linked polystyrenesulfonic acid, polyacrylic acid, polyvinylsulfonic acid, poly(2-acrylamide-2-methylpropylsulfonic acid), sulfonated polyimides, sulfonated polysulfone, sulfoaklylated polysulfones, sulfonated polycarbonates, poly(ρ-phenylene) substituted with sulfophenoxy benzyl groups, sulfonated polyquinoxalines, sulfonated (phosphonated) polyphosphazene, sulfonated polyketones, sulfonated poly(phenylene oxides), polybenzimidazole, sulfonated polyether sulfone, sulfonated polyether ketone, sulfonated polyether ether ketone, sulfonated polyphenylene sulfide, sulfonated polyphenylene sulfone, sulfonated polyphenylene sulfide sulfone, sulfonated polyphenylene sulfide sulfone nitrile, sulfonated polysulfide ketone, sulfonated polyarylene ether, sulfonated polyarylene ether nitrile, sulfonated polyarylene ether nitrile, sulfonated polyarylene ether sulfone ketone, and sulfonated polyarylene ether sulfone.

In some embodiments, the term “hydrocarbon-based ion exchange membrane” refers to any ion exchange membrane whose polymeric backbone is composed predominantly (e.g., at least 50%, 60%, 70%, 80%, 90%, etc.) of hydrocarbon units (e.g., aromatic or aliphatic hydrocarbon structures) rather than fluorocarbon units. Examples include, but are not limited to, polyethersulfone, cross-linked polystyrenesulfonic acid, sulfonated polysulfone, sulfonated polyimides, sulfonated poly(phenylene oxide), sulfonated polyether ether ketone (sPEEK), or combinations thereof. Such membranes typically differ from fluorine-based membranes (e.g., Nafion) in that they generally have higher glass transition temperatures (on the order of about 200° C. or higher) and do not contain fluorinated backbones. In certain embodiments, the hydrocarbon-based ion exchange membrane has an ion exchange capacity (IEC) of at least about 2.0 meq/g to allow for sufficient hydration (water uptake).

In general, since the hydrocarbon-based ion exchange membrane 100 having an ion exchange capacity (IEC) of 2.0 meq/g or more is widely used for high hydrogen ion conductivity, the hydrocarbon-based ion exchange membrane 100 can absorb a large amount of water. As shown in FIG. 2, as the hydrocarbon-based ion exchange membrane 100 absorbs water, its volume expands, and it may be plasticized. Here, plasticization may mean that the hydrocarbon-based ion exchange membrane 100 becomes soft to flow easily.

Specifically, the hydrocarbon-based ion exchange membrane 100 may be immersed in a solvent at 70° C. to 90° C. for 4 to 6 hours to obtain the first intermediate 200. If the immersion temperature is less than 70° C., the dimensional change rate of the hydrocarbon-based ion exchange membrane 100 is low and the Young's modulus is not sufficiently reduced, so that patterning using a template to be described later may not be performed properly. The solvent may include water. In some embodiments, the term “solvent” means any liquid or liquid mixture in which the hydrocarbon-based ion exchange membrane can be immersed or contacted in order to hydrate (absorb water) and undergo plasticization. In some embodiments, water is the primary solvent used to hydrate the membrane. However, other solvents (including water-based mixtures or additional co-solvents) may be used so long as they allow sufficient water absorption in the membrane to achieve the dimensional change and reduction in mechanical stiffness that facilitates pattern formation.

The first intermediate 200 obtained by immersing the hydrocarbon-based ion exchange membrane 100 in a solvent of about 80° C. for about 4 hours may have a moisture content of 60% by weight or more. The moisture content may mean the percentage of the mass of the solvent in the total mass of the first intermediate 200. The moisture content of the first intermediate 200 may be calculated by measuring the mass of the first intermediate 200 and the mass of the hydrocarbon-based ion exchange membrane 100. The upper limit of the moisture content is not particularly limited, and may be, for example, 80% by weight or less, 75% by weight or less, or 70% by weight or less.

When the water content of the first intermediate 200 is 60% by weight or more, the dimensional change rate of the hydrocarbon-based ion exchange membrane 100 is high, and accordingly, sufficient space for forming a pattern in the electrolyte membrane 10 may be provided.

When the hydrocarbon-based ion exchange membrane 100 is immersed in a solvent at about 80° C. for about 4 hours, the hydrocarbon-based ion exchange membrane 100 may have a length change rate of 10% or more and a thickness change rate of 30% or more. The upper limit of the length change rate is not particularly limited, and may be, for example, 20% or less. The upper limit of the thickness change rate is not particularly limited, and may be, for example, 50% or less. The hydrocarbon-based ion exchange membrane 100 may have a sheet shape composed of a long side and a short side, and the long side may be referred to as a length L and the short side may be referred to as a width W. Referring to FIG. 2, the length change rate may mean a difference between the length L of the hydrocarbon-based ion exchange membrane 100 before immersion and the length L′ of the first intermediate 200 after immersion. The thickness change rate may refer to a difference between the thickness T of the hydrocarbon-based ion exchange membrane 100 before immersion and the thickness T′ of the first intermediate 200 after immersion.

The length L of the hydrocarbon-based ion exchange membrane 100 is not particularly limited, and may be, for example, 500 mm or more. The thickness T of the hydrocarbon-based ion exchange membrane 100 is not particularly limited, and may be, for example, 30 μm to 100 μm.

The hydrocarbon-based ion exchange membrane 100 is characterized in that the change rate of the thickness T is greater than the change rate of the length L. Therefore, the hydrocarbon-based ion exchange membrane 100 may provide sufficient space for forming a pattern in the direction of the thickness T.

The first intermediate 200 obtained by immersing the hydrocarbon-based ion exchange membrane 100 in a solvent at about 80° C. for about 4 hours may have a Young's modulus of 100 MPa or less. The lower limit of the Young's modulus is not particularly limited, and may be, for example, 50 MPa or more. When the Young's modulus of the first intermediate 200 is 100 MPa or less, the first intermediate 200 may be subjected to creep deformation by pressure applied through the template.

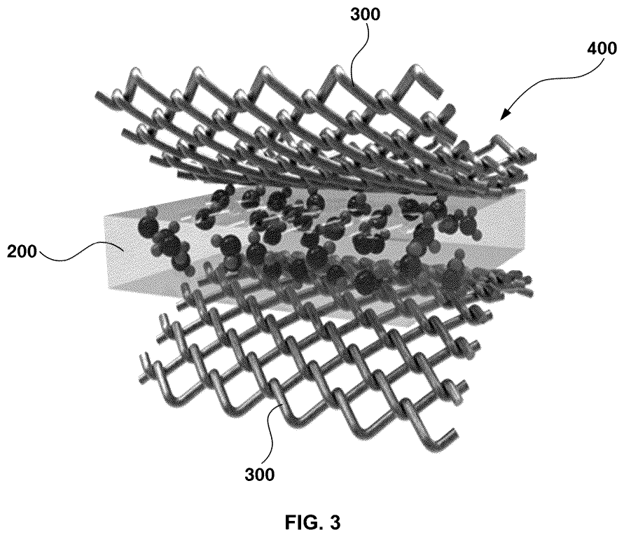

FIG. 3 is for explaining the step of obtaining the second intermediate. The second intermediate 400 may be obtained by stacking a template 300 on at least one surface, preferably both surfaces, of the first intermediate 200 and applying pressure in the direction in which the template 300 is stacked.

The template 300 may have a mesh-shape or be in the form of a mesh in which wires are intertwined in a net shape. In some embodiments, the term “mesh-shape” with respect to a template refers to a net-like structure formed by intersecting wires or filaments. The diameter of the wire is not particularly limited, and may be, for example, 10 μm to 30 μm. The diameter of the wire may refer to the diameter of a cross-section of the wire cut perpendicular to the longitudinal direction. The grid spacing of the template 300 is not particularly limited, and may be, for example, 10 μm to 30 μm. The grid spacing of the template 300 may refer to a spacing between the wires forming the net shape. The aperture ratio of the template 300 is not particularly limited, and may be, for example, 10% to 50%. The aperture ratio of the template 300 may refer to an area of the spacing between the wires of the total area of the template 300.

The material of the template 300 may preferably have higher stiffness than that of the first intermediate 200. Since the first intermediate 200 is a hydrated hydrocarbon-based ion exchange membrane 100, the stiffness (e.g., Young's modulus) thereof may be from several MPa to several tens of MPa. Since the creep deformation of the first intermediate 200 needs to be caused using the template 300, the stiffness of the template 300 needs to be at least higher than the stiffness of the first intermediate 200. Specifically, the template 300 may include stainless steel. In some embodiments, the template 300 may be made of stainless steel.

The template 300 may have a width of 300 mm or more and a length of 500 mm or more. The upper limits of the width and length of the template 300 are not particularly limited and may be appropriately adjusted according to the intended size of the first intermediate 200. The size of the first intermediate 200 may refer to the width and length of the first intermediate 200, and the size of the first intermediate 200 may be equal to, larger than, or smaller than the size of the template 300. For example, the size of the first intermediate 200 may be 90% to 110% of the size of the template 300. According to the present disclosure, since the size of the template 300 is freely adjusted, it may be advantageous in preparing a large-area patterned electrolyte membrane compared to conventional technologies such as a patterning method using an ionomer solution, a patterning method using nanoparticles, a patterning method using plasma, etc.

The second intermediate 400 may be in the form of the template 300 being imprinted into at least one surface, preferably both surfaces, of the first intermediate 200.

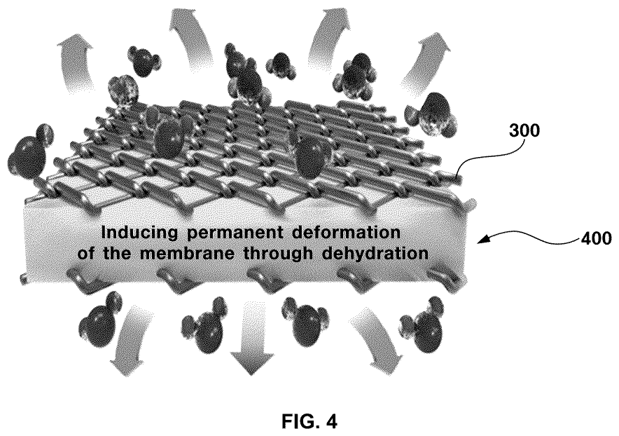

The step of obtaining the second intermediate 400 may be stacking the template 300 on at least one surface, preferably both surfaces, of the first intermediate 200, and applying a pressure of 5 MPa to 15 MPa in the stacking direction at 70° C. to 90° C. to subject the first intermediate 200 to creep deformation. Here, creep deformation may mean a phenomenon in which deformation continues with the passage of time in a state in which a constant load is applied to the first intermediate 200. When the temperature and pressure conditions are satisfied, the first intermediate 200 may be subjected to creep deformation by the template 300. FIG. 4 is for explaining the step of obtaining the electrolyte membrane.

The electrolyte membrane may be obtained by dehydrating the second intermediate 400 and removing the template 300 from the second intermediate 400. Since the first intermediate 200 returns to a hydrocarbon-based ion exchange membrane 100 and recovers its mechanical properties when the first intermediate 200 is dehydrated in a state in which it is restrained by the template 300, creep recovery deformation may be minimized when the template 300 is removed, so a shape corresponding to the shape of the template 300 remains permanently on at least one surface, preferably both surfaces, of the hydrocarbon-based ion exchange membrane 100. In some embodiments, the term “corresponding to” means that the shape, dimension, or pattern on the membrane substantially reflects or matches the geometry of the template. In particular, when the membrane is imprinted under pressure by the template, the resulting embedded pattern is formed so that it aligns with (i.e., is derived from) the contours or openings of the template.

The step of obtaining the electrolyte membrane may be compressing the second intermediate 400 at 70° C. to 90° C. for 1 to 2 hours to dehydrate it and removing the template. When the temperature and time conditions of the compression are satisfied, the second intermediate 400 may be sufficiently dehydrated.

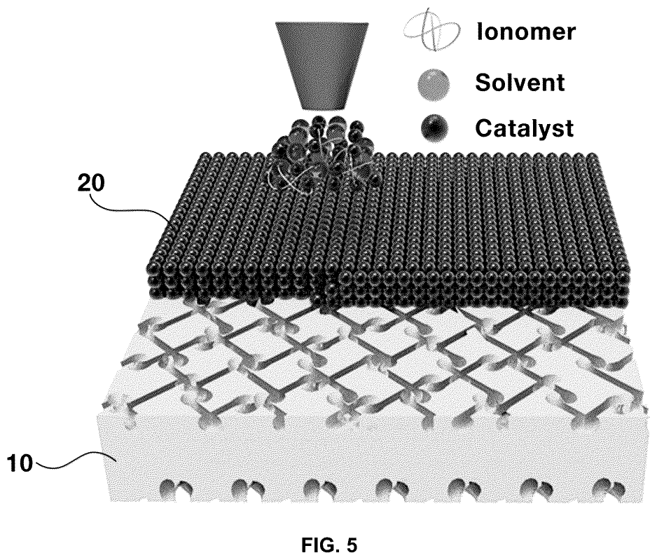

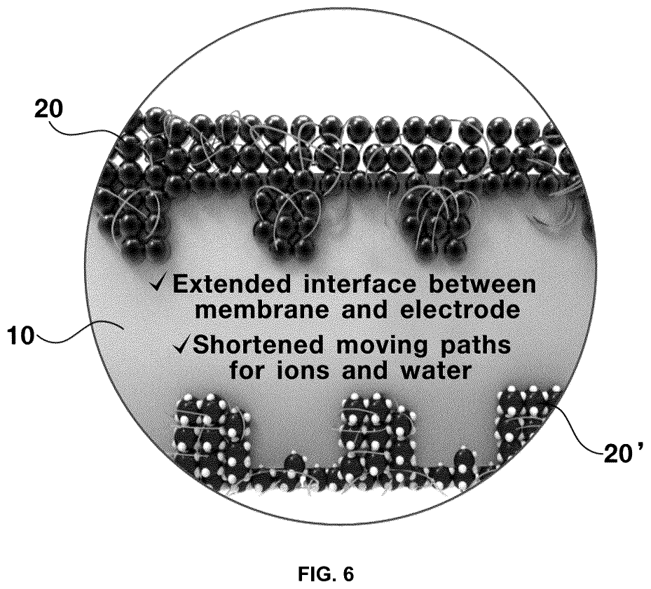

FIG. 5 is for explaining a method for manufacturing a membrane-electrode assembly according to the present disclosure. FIG. 6 is an enlarged view of a cross-section of a membrane-electrode assembly according to the present disclosure.

The method for manufacturing a membrane-electrode assembly may include a step of manufacturing a pair of electrodes 20 and 20′ by applying a catalyst slurry to both surfaces of the electrolyte membrane 10.

A pattern having a shape corresponding to the shape of the template 300 may be formed to be embedded in at least one surface, preferably both surfaces, of the electrolyte membrane 10.

The depth of the pattern formed to be embedded in the electrolyte membrane 10 may be 40% or more of the diameter of the cross-section of the wire of the template 300. The upper limit of the depth of the pattern is not particularly limited, and may be, for example, 80% or less, 70% or less, or 60% or less. If the depth of the pattern is less than 40%, the flow of water of the electrolyte membrane 10 and the degree of improvement in hydrogen ion conductivity may be minimal, and if it exceeds 80%, the mechanical properties of the electrolyte membrane 10 may deteriorate.

The catalyst slurry may contain a catalyst, an ionomer, a solvent, etc.

The catalyst may include platinum supported on a carbon support (Pt/C). The content of platinum is not particularly limited, and may be, for example, about 40% by weight to 60% by weight based on the total weight of the catalyst.

The ionomer may include a perfluorosulfonic acid-based ionomer, a hydrocarbon-based ionomer, etc. The perfluorosulfonic acid-based ionomer may have a main chain of polytetrafluoroethylene (PTFE) and a side chain containing a sulfonic acid group (—SO₃H) and may preferably include Nafion. The hydrocarbon-based ionomer may be the same as the hydrocarbon-based ion exchange membrane 100 described above.

The solvent may include an alcohol-based organic solvent, an amide-based organic solvent, a ketone-based organic solvent, a carbonate-based organic solvent, an ether-based organic solvent, etc. The alcohol-based organic solvent may include an alcohol having 1 to 4 carbon atoms. The amide-based organic solvent may include formamide (FA), N-methyl formamide (NMFA), N,N-dimethyl formamide (DMF), acetamide (AA), N-methyl acetamide (NMAA), N,N-dimethyl acetamide (DMA), N-methyl-2-pyrrolidone (NMP), etc., and preferably N-methyl-2-pyrrolidone (NMP). The ketone-based organic solvent may include acetone, methylethylketone (MEK), methylbutylketone (MBK), methylisobutylketone (MIBK), etc. The carbonate-based organic solvent may include ethylene carbonate, propylene carbonate, 1,2-butylene carbonate, 2,3-butylene carbonate, 1,2-pentylene carbonate, 2,3-pentylene carbonate, vinylene carbonate, dimethyl carbonate, diethyl carbonate, dipropyl carbonate, ethylmethyl carbonate (EMC), methylpropyl carbonate, ethylpropyl carbonate, etc. The ether-based organic solvent may include ethylene glycol dimethyl ether, ethylene glycol diethyl ether, ethylene glycol dipropyl ether, ethylene glycol dibutyl ether, propylene glycol dimethyl ether, propylene glycol diethyl ether, propylene glycol dibutyl ether, diethylene glycol dimethyl ether, diethylene glycol methyl ethyl ether, diethylene glycol diethyl ether, 1,4-dioxane, tetrahydrofuran, anisole, etc.

The catalyst slurry may have a solid concentration of 10% by weight to 15% by weight. The solid concentration may mean the content of solid components such as a catalyst, ionomer, etc. excluding the content of the solvent in the catalyst slurry.

A method for preparing the catalyst slurry is not particularly limited, and for example, the catalyst slurry may be prepared by adding a catalyst and an ionomer to a solvent, mixing them with a paste mixer for about 30 minutes, and then dispersing them with a high-shear homogenizer for about 60 minutes, and defoaming them for about 20 minutes.

The catalyst slurry may be coated on the electrolyte membrane 10 in a spray or bar coating manner to manufacture an electrode 20. Since a pattern having a shape corresponding to the shape of the template 300 is formed to be embedded in at least one surface, preferably both surfaces, of the electrolyte membrane 10, the catalyst slurry may fill the pattern and form an electrode 20 as shown in FIG. 6. Accordingly, the interface between the electrolyte membrane 10 and the electrode 20 is expanded so that the adhesion strength between the two components may be increased, which may lead to improved electrochemical performance of the membrane-electrode assembly.

Hereinafter, other embodiments of the present disclosure will be described in more detail through Preparation Examples and an Example. The following Preparation Examples and Example are merely examples to help understand the present disclosure, and the scope of the present disclosure is not limited thereto.

### Preparation Example 1-1

A first intermediate was prepared by hydrating a hydrocarbon-based ion exchange membrane.

A Piperion anion exchange membrane from Versogen was used as the hydrocarbon-based ion exchange membrane. The thickness of the hydrocarbon-based ion exchange membrane was about 40 μm. The hydrocarbon-based ion exchange membrane was immersed in water at about 80° C. for about 4 hours.

### Comparative Preparation Example 1-1

A first intermediate was prepared by immersing the same hydrocarbon-based ion exchange membrane as Preparation Example 1-1 in water at about 30° C. for about 4 hours.

### Comparative Preparation Example 2-1

A first intermediate was prepared by immersing the same hydrocarbon-based ion exchange membrane as Preparation Example 1-1 in water at about 50° C. for about 4 hours.

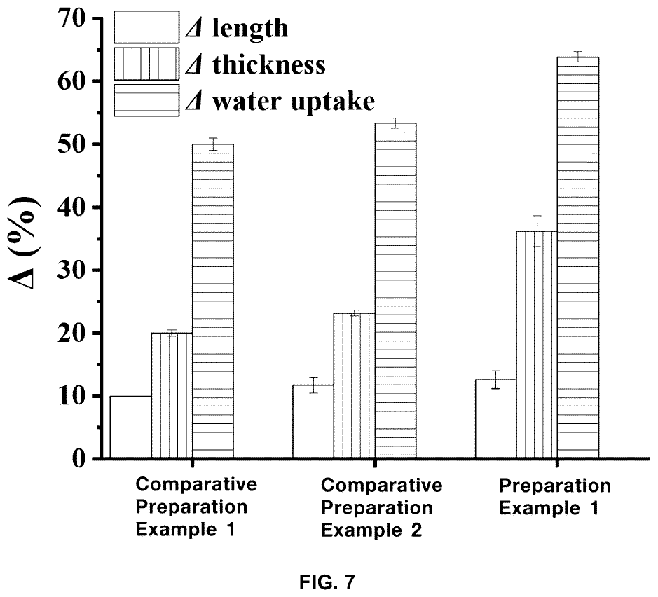

FIG. 7 shows length change rates, thickness change rates, and moisture contents of the first intermediates according to Preparation Example 1-1, Comparative Preparation Example 1-1, and Comparative Preparation Example 2-1. Specific numerical values are shown in Table 1 below.

TABLE 1

| | Comparative | Comparative | |
|---|---|---|---|
| | Preparation | Preparation | Preparation |
| | Example | Example | Example |
| Item | 1-1 | 2-1 | 1-1 |
| Moisture | 50 ± 0.9804 | 53.3889 ± 0.778 | 63.8597 ± 0.846 |
| content | | | |
| [% by weight] | | | |
| Length change | 10 | 11.75 ± 1.25 | 12.6 ± 1.4 |
| rate [%] | | | |
| Thickness | 20.005 ± 0.508 | 23.167 ± 0.44 | 36.1742 ± 2.462 |
| change | | | |
| rate [%] | | | |

Referring to FIG. 7 and Table 1, the higher the hydration temperature of the hydrocarbon-based ion exchange membrane, the greater the dimensional change rate and moisture content. As in Preparation Example 1, when the hydration temperature is 80° C. or higher, it can be seen that the thickness change rate is 30% or higher, which may provide sufficient space for pattern formation.

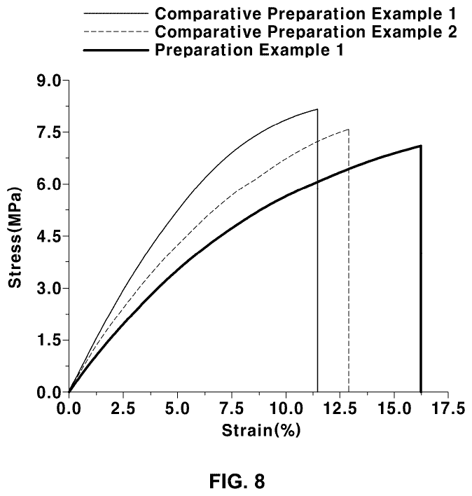

FIG. 8 shows tensile strengths of the first intermediates according to Preparation Example 1-1, Comparative Preparation Example 1-1, and Comparative Preparation Example 2-1. The tensile strength, Young's modulus, and elongation at break of each first intermediate are shown in Table 2 below.

TABLE 2

| | Comparative | Comparative | |
|---|---|---|---|
| | Preparation | Preparation | Preparation |
| | Example | Example | Example |
| Item | 1-1 | 2-1 | 1-1 |
| Tensile strength | 8.177945 | 7.85165 | 7.112 |
| [MPₐ] | | | |
| Young's modulus | 124.61 | 101.69 | 89.41 |
| [MPₐ] | | | |
| Elongation at break | 11.4625 | 12.8975 | 16.23 |
| [%] | | | |

In view of the fact that the Young's modulus, which indicates mechanical stiffness, is the lowest in Preparation Example 1-1, where the hydration temperature is 80° C., it can be seen that the greatest degree of plasticization has been made. Therefore, the first intermediate of Preparation Example 1-1 may be subjected to creep deformation due to mechanical stress, and a patterning process can be possible through this.

### Preparation Example 1-2

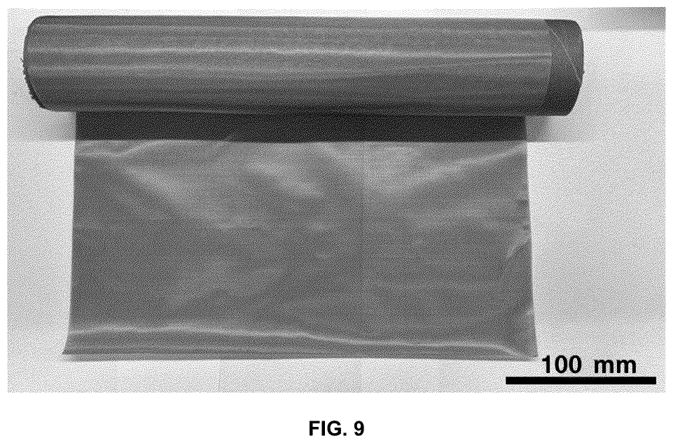

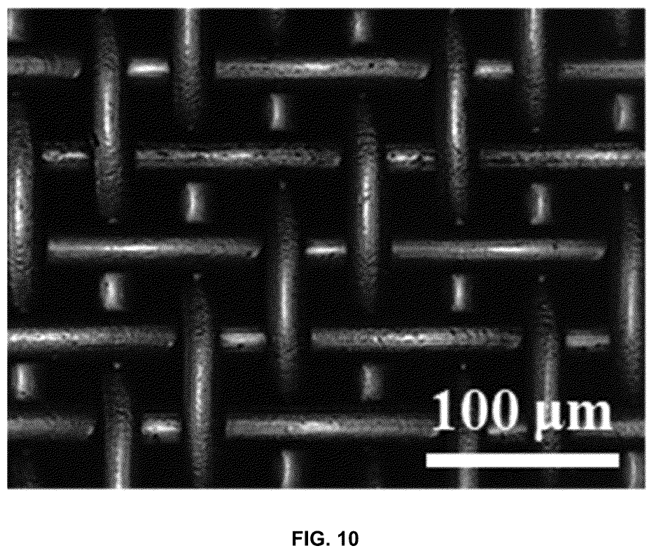

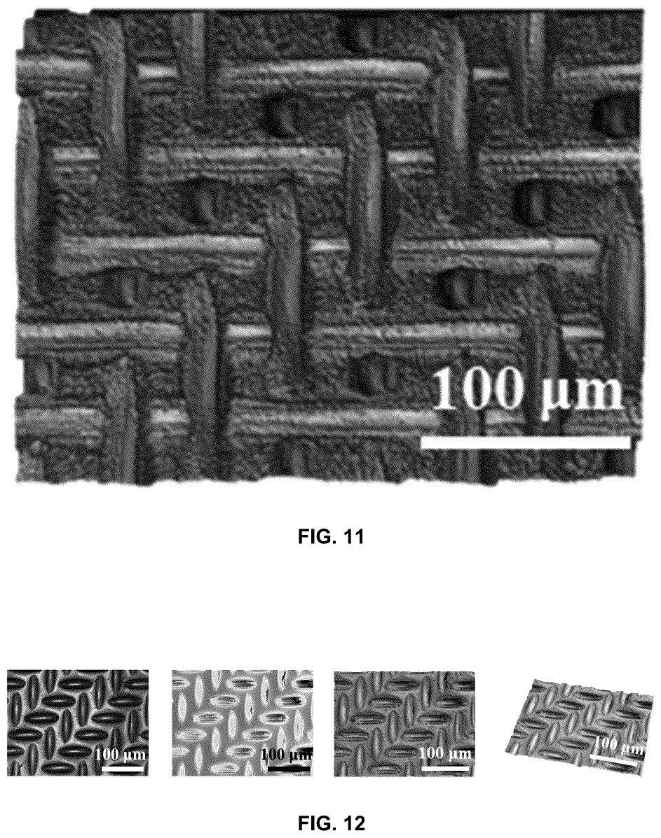

FIG. 9 is a template used in Preparation Example 1-2. FIG. 10 is an optical image of the template of FIG. 9. FIG. 11 is a laser profile image of the template of FIG. 9.

A mesh made of SUS316L material, which is provided in a roll type with a width of about 300 mm and a length of about 500 mm, was used as a template. The diameter of the wires constituting the template is about 20 μm, the spacing between the wires is about 20 μm, and the aperture ratio thereof is about 25%. The stiffness of the template is about 176 GPₐ, which is higher than that of the first intermediate of Preparation Example 1-1.

After stacking the template on both surfaces of the first intermediate of Preparation Example 1-1, a pressure of about 10 MPa was applied in the stacking direction at about 80° C. to obtain a second laminate.

The second laminate was dehydrated by compressing it at about 80° C. for about 1 to 2 hours, and then the template was removed to obtain an electrolyte membrane.

### Comparative Preparation Example 1-2

An electrolyte membrane was prepared in the same manner as Preparation Example 1-2 except that the first intermediate of Comparative Preparation Example 1-1 was used.

### Comparative Preparation Example 2-2

An electrolyte membrane was prepared in the same manner as Preparation Example 1-2 except that the first intermediate of Comparative Preparation Example 2-1 was used.

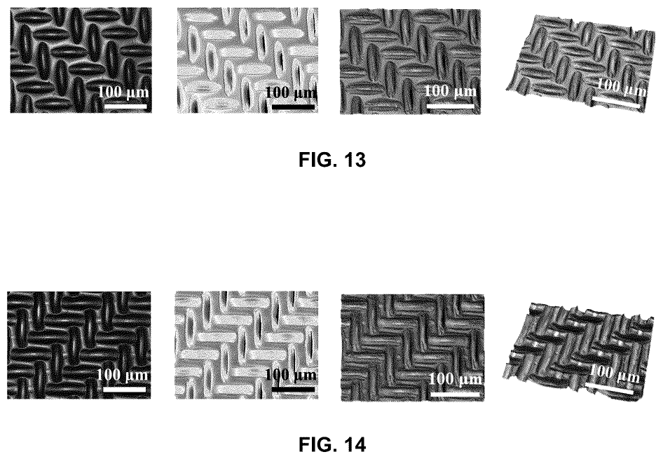

FIG. 12 is optical images and laser profile images of the electrolyte membrane according to Comparative Preparation Example 1-2. FIG. 13 is optical images and laser profile images of the electrolyte membrane according to Comparative Preparation Example 2-2. FIG. 14 is optical images and laser profile images of the electrolyte membrane according to Preparation Example 1-2.

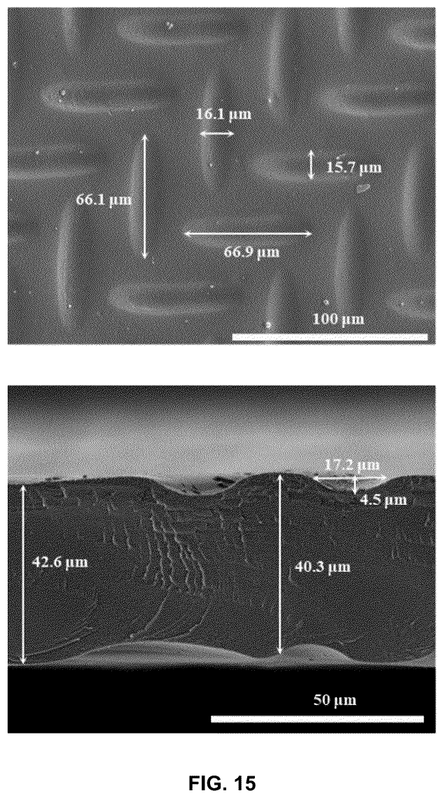

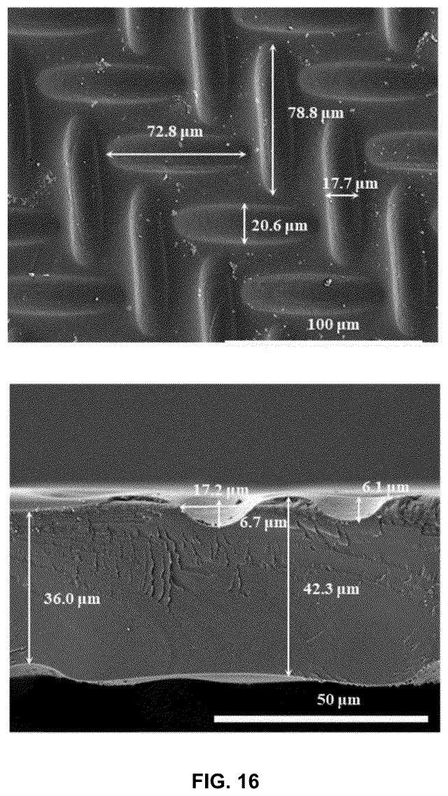

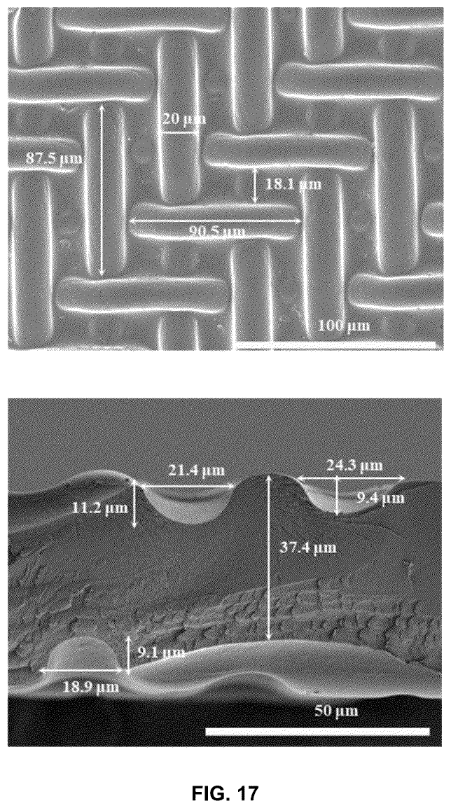

FIG. 15 are images illustrating results of analyzing the surface and cross-section of the electrolyte membrane according to Comparative Preparation Example 1-2 using a scanning electron microscope. FIG. 16 are images illustrating results of analyzing the surface and cross-section of the electrolyte membrane according to Comparative Preparation Example 2-2 using a scanning electron microscope. FIG. 17 are images illustrating results of analyzing the surface and cross-section of the electrolyte membrane according to Preparation Example 1-2 using a scanning electron microscope.

In the electrolyte membrane of Preparation Example 1-2, where the reduction in mechanical stiffness of the first intermediate was the greatest, that is, plasticization occurred the most and the thickness change rate was the greatest, the shape of the pattern was clearly imprinted. Looking at the scanning electron microscope results of the cross-section, the electrolyte membrane of Preparation Example 1-2 has a pattern depth of about 47% or more of the diameter of the wires constituting the template. On the other hand, the electrolyte membranes of Comparative Preparation Example 1-2 and Comparative Preparation Example 2-2 had low pattern fidelity.

### Example

A membrane-electrode assembly was manufactured by the following method. A catalyst slurry containing Pt/C, an ionomer, and an alcohol-based solvent was coated on both surfaces of the electrolyte membrane of Preparation Example 1-2 by a spray coating method to form an electrode.

### Comparative Example

A membrane-electrode assembly was manufactured in the same manner as the Example by using an electrolyte membrane without a pattern formed on the surface. A Piperion anion exchange membrane from Versogen with a thickness of about 40 μm was used as the electrolyte membrane.

Table 3 below shows the thickness, tensile strength, Young's modulus, and elongation at break of the electrolyte membranes used in the Example and Comparative Example.

TABLE 3

| Item | Comparative Example | Example |
|---|---|---|
| Thickness [μm] | 40 | 38.74 |
| Tensile strength [MPa] | 45.679 | 42.97 |
| Young's modulus [MPa] | 980.59 | 1084.2 |
| Elongation at break [%] | 16.632 | 18.166 |

Referring to Table 3, the electrolyte membranes of the Example and the Comparative Example have substantially the same thickness, tensile strength, Young's modulus, and elongation at break. The thickness decreased and the Young's modulus increased in the Example due to compression for dehydration during the patterning process.

It can be confirmed that the mechanical properties of the electrolyte membranes are not affected even if the patterning process is performed in that the electrolyte membrane of the Example was subjected to the above-described patterning processes of Preparation Examples 1-1 and 1-2 performed on the electrolyte membrane of the Comparative Example.

Table 4 below shows the resistance and hydrogen ion conductivity of the electrolyte membranes used in the Example and Comparative Example. The hydrogen ion conductivity was measured using a 4-point measurement method.

TABLE 4

| Item | Comparative Example | Example |
|---|---|---|
| Resistance [Ω] | 2,250 | 2,220 |
| Hydrogen ion conductivity | 111.11 | 116.28 |
| [mS · cm⁻¹] | | |

Referring to Table 4, the electrolyte membrane of the Example has lower resistance and higher hydrogen ion conductivity than the electrolyte membrane of the Comparative Example. It can be seen that the patterning process according to the present disclosure does not adversely affect the electrochemical properties of the electrolyte membrane, but rather, the hydrogen ion conductivity is increased by improving the hydrogen ion transfer characteristics in a local area by pattern formation.

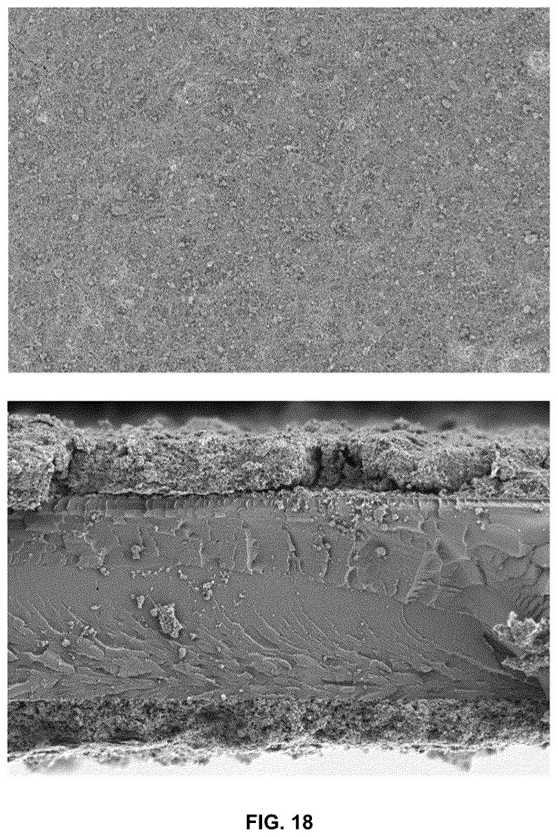

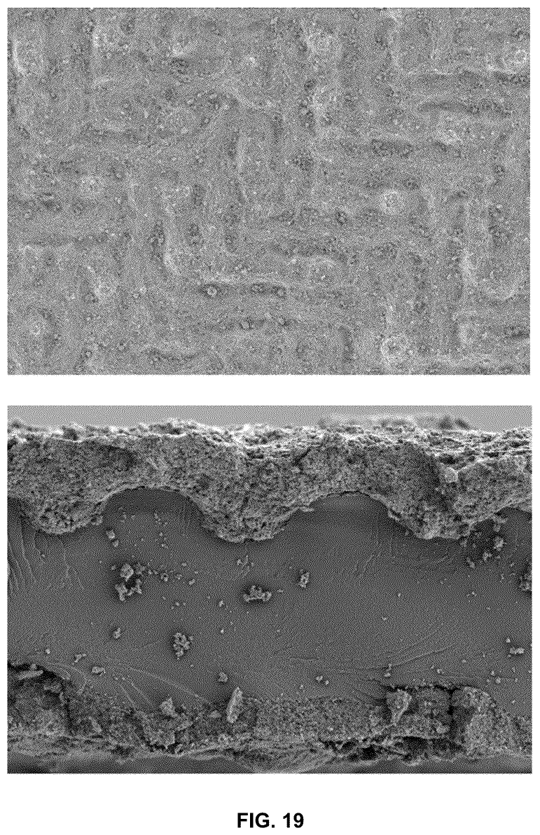

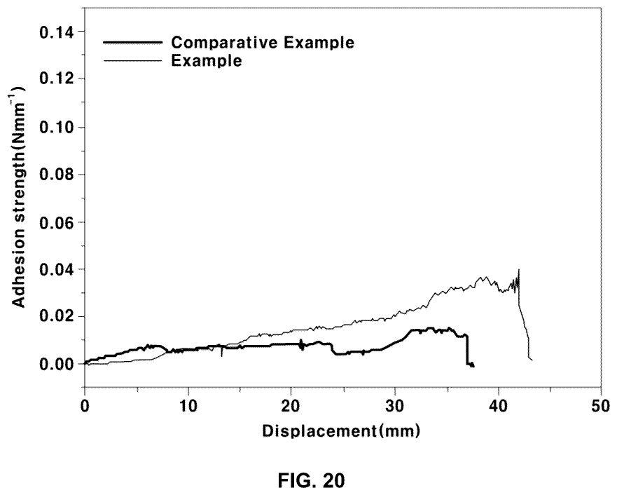

FIG. 18 are images illustrating results of analyzing the surface and cross-section of the membrane-electrode assembly according to the Comparative Example using a scanning electron microscope. FIG. 19 are images illustrating results of analyzing the surface and cross-section of the membrane-electrode assembly according to the Example using a scanning electron microscope. Referring to FIG. 19, it can be seen that the membrane-electrode assembly according to the Example has an electrode well-formed along the pattern of the electrolyte membrane. This is a result different from that of the interface of the Comparative Example between the electrolyte membrane in which the pattern is not formed and the electrode. According to the Example, the bonding force is improved by the interlocking structure of the interface between the electrolyte membrane and the electrode, and this may lead to improved durability. In addition, the electrolyte membrane locally thinned by the pattern may promote the movement of water and hydrogen ions, thereby reducing resistance and improving mass transfer characteristics. In order to confirm such effects, the shear stress and adhesion strength of each membrane-electrode assembly were measured to evaluate the interfacial adhesion of the membrane-electrode assemblies according to the Example and Comparative Example. FIG. 20 is a graph illustrating results of measuring adhesion strengths of the membrane-electrode assemblies according to the Example and Comparative Example. Specifically, the adhesion strengths were measured using a peel-off strength tester. Table 5 below shows the shear stress and adhesion strength of the membrane-electrode assemblies according to the Example and Comparative Example.

TABLE 5

| Item | Comparative Example | Example |
|---|---|---|
| Shear stress [MPₐ] | 0.1367 | 0.1551 |
| Adhesion strength [N · mm⁻¹] | 0.0153 | 0.0404 |

Referring to FIG. 20 and FIG. 5, the shear stress of the Example is improved by about 13.4% compared to the Comparative Example, and the adhesion strength of the Example is improved by about 164.05% compared to the Comparative Example.

The strong bonding force between the electrolyte membrane and the electrode shown in the Example means that the detachment problem occurring in the long-term operation of the electrochemical device utilizing it can be effectively alleviated to improve durability.

Hereinabove, the Examples of the present disclosure have been described in detail, but the scope of the rights of the present disclosure is not limited to the above-described Examples, and various modifications and improved forms made by those skilled in the art using the basic concept of the present disclosure defined in the following patent claims are also included in the scope of the rights of the present disclosure.

What is claimed is:

1. A method for preparing an electrolyte membrane for a membrane-electrode assembly, the method comprising:
obtaining a first intermediate by hydrating a hydrocarbon-based ion exchange membrane [symbol] ;
obtaining a second intermediate by stacking a template on at least one surface of the first intermediate and applying pressure in the stacking direction; and
obtaining the electrolyte membrane by dehydrating the second intermediate and removing the template from the second intermediate,
wherein the electrolyte membrane comprises a pattern having a shape corresponding to the template.

2. The method of claim 1, wherein the step of obtaining the first intermediate is immersing the hydrocarbon-based ion exchange membrane in a solvent at about 70° C. to 90° C. for about 4 to 6 hours.

3. The method of claim 1, wherein the first intermediate obtained by immersing the hydrocarbon-based ion exchange membrane in a solvent at about 80° C. for about 4 hours has a moisture content of about 60% by weight or more.

4. The method of claim 1, wherein when the hydrocarbon-based ion exchange membrane is immersed in a solvent at about 80° C. for about 4 hours, the hydrocarbon-based ion exchange membrane has a length change rate of about 10% or more.

5. The method of claim 1, wherein when the hydrocarbon-based ion exchange membrane is immersed in a solvent at about 80° C. for about 4 hours, the hydrocarbon-based ion exchange membrane has a thickness change rate of about 30% or more.

6. The method of claim 1, wherein the first intermediate obtained by immersing the hydrocarbon-based ion exchange membrane in a solvent at about 80° C. for about 4 hours has a Young's modulus of about 100 MPa or less.

7. The method of claim 1, wherein the template has a mesh-shape in which wires are intertwined in a net-like shape.

8. The method of claim 1, wherein the template has a stiffness higher than a stiffness of the first intermediate.

9. The method of claim 1, wherein the template comprises stainless steel.

10. The method of claim 1, wherein the template has a width of about 300 mm or more and a length of about 500 mm or more, and the first intermediate has a size equal to or larger than a size of the template.

11. The method of claim 1, wherein the template has a width of about 300 mm or more and a length of about 500 mm or more, and the first intermediate has a size equal to or smaller than a size of the template.

12. The method of claim 1, wherein the step of obtaining the second intermediate is stacking the template on at least one surface of the first intermediate, and applying a pressure of about 5 MPa to 15 MPa in the stacking direction at about 70° C. to 90° C.

13. The method of claim 1, wherein the step of obtaining the electrolyte membrane is dehydrating the second intermediate by compressing the second intermediate at about 70° C. to 90° C. for about 1 hour to 2 hours and removing the template.

14. A method for manufacturing a membrane-electrode assembly, the method comprising a step of applying a catalyst slurry to both surfaces of the electrolyte membrane prepared according to claim 1 to manufacture a pair of electrodes, wherein the electrodes are filled in spaces of the electrolyte membrane formed to be embedded.

15. An electrolyte membrane for a membrane-electrode assembly, the electrolyte membrane comprising a hydrocarbon-based ion exchange membrane,
wherein the hydrocarbon-based ion exchange membrane has a pattern with a shape corresponding to a pattern of a template, the pattern being formed to be embedded in at least one surface of the hydrocarbon-based ion exchange membrane, and the template has a mesh-shape in which wires are intertwined in a net-like shape.

16. The electrolyte membrane of claim 15, wherein the hydrocarbon-based ion exchange membrane has a moisture content of about 60% by weight or more.

17. The electrolyte membrane of claim 15, wherein the hydrocarbon-based ion exchange membrane has a longitudinal change rate of about 10% or more.

18. The electrolyte membrane of claim 15, wherein the hydrocarbon-based ion exchange membrane has a width directional change rate of about 30% or more.

19. The electrolyte membrane of claim 15, the hydrocarbon-based ion exchange membrane has a Young's modulus of about 100 MPa or less.

20. The electrolyte membrane of claim 15, wherein the pattern formed to be embedded in the hydrocarbon-based ion exchange membrane has a depth of about 40% or more of the diameter of the cross section of the wires of the template.
